(19) United States
(12) Patent Application Publication
(10) Pub. No.: US 2026/0285141 A1
(43) Pub. Date: Sep. 24, 2026

(54) TRANSMISSION MODULE FOR A HYBRID DRIVE VEHICLE

(71) Applicant: MUVIQ S.R.L., Ivrea (IT)

(72) Inventors: Vittorio CAPONIO, SAN BERNARDO D'IVREA (IT); Federico Domenico LICATA, SAN BERNARDO D'IVREA (IT); Marco CASALONE, SAN BERNARDO D'IVREA (IT); Gianluca CARICCIA, SAN BERNARDO D'IVREA (IT)

(73) Assignee: MUVIQ S.R.L., Ivrea (IT)

(21) Appl. No.: 19/100,642

(22) PCT Filed: Aug. 1, 2023
(86) PCT No.: PCT/IB2023/057794

§ 371 Date: Feb. 3, 2025

(30) Foreign Application Priority Data
Aug. 4, 2022 (IT) 102022000016713

(51) Int. Cl. B60K 6/50; B60K 6/48

(52) U.S. Cl. CPC B60K 6/50; B60K 6/48

(57) ABSTRACT

Transmission modules for a hybrid drive assembly for a vehicle are disclosed herein. The hybrid drive assembly includes an internal combustion engine (ICE) provided with a drive shaft, at least one electrical machine and a transmission of the vehicle. The transmission module is configured to be interposed between the ICE and the transmission and has a support structure configured to be secured to the engine and defining a housing and a transmission assembly housed in the housing. The transmission assembly has a first element that has an axis (A) coincident, in use, with an axis of the drive shaft and is configured to be operatively connected to the engine and the electrical machine, and a second element that is configured to be connected to the transmission of the vehicle. The first element and the second element are distinct components which are rigidly coupled to each other.

### CROSS-REFERENCE TO RELATED APPLICATIONS

This Patent Application claims priority from Italian Patent Application No. 102022000016713 filed on Aug. 4, 2022, the entire disclosure of which is incorporated herein by reference.

### TECHNICAL FIELD

The present invention relates to a transmission module for a hybrid drive vehicle, and in particular to a transmission module configured to be interposed between an internal combustion engine and a transmission of a hybrid drive vehicle.

### BACKGROUND ART

As is known, hybrid drive vehicles comprise an internal combustion engine and at least one electrical machine which can be used as a generator or as a motor to supply drive torque in combination with (o as an alternative to) the internal combustion engine, depending on the operating conditions of the vehicle.

A configuration wherein an electrical machine is used connected between the internal combustion engine and the transmission of the vehicle is conventionally referred to as “P2” or “P1” on the basis of, respectively, the presence or the absence of some elements, specified hereinafter.

In particular, a transmission module configured to be interposed between the internal combustion engine and the transmission of a vehicle is conventionally referred to as:
“P2 module” if it comprises, besides the electrical machine, a clutch to selectively connect the internal combustion engine and the electrical machine to each other;
“P1 module” if it comprises the electrical machine but is devoid of such clutch.

Therefore, a P1 module can be considered a particular case of P2 module, since the internal combustion engine and the electrical machine are permanently connected to each other.

A problem connected to the known P1 modules is the manufacturing of their components, which have complex geometries and expensive production processes. In particular, the mounting of a P1 module is particularly complex and thus extends the manufacturing time and the relative costs.

A purpose of the present invention is to provide a transmission module of P1 type, which allows the aforementioned problems to be overcome.

### DISCLOSURE OF THE INVENTION

The aforementioned purpose is achieved by a module according to the appended claims.

### BRIEF DESCRIPTION OF THE DRAWINGS

For a better understanding of the present invention, a preferred embodiment is described hereinafter, by way of non-limiting example and with reference to the accompanying drawings, wherein:

FIG. 1 is an exploded view of a hybrid unit comprising a transmission module according to a first embodiment of the present invention;

FIG. 2 is an axial cross-sectional view of the unit of FIG. 1;

FIG. 3 is a view, in enlarged scale, of a detail of FIG. 2;

FIG. 4 is an exploded view of a hybrid unit comprising a transmission module according to a second embodiment of the present invention;

FIG. 5 is an axial cross-sectional view of the unit of FIG. 4; and

FIG. 6 is a view, in enlarged scale, of a detail of FIG. 5.

### DETAILED DESCRIPTION OF THE INVENTION

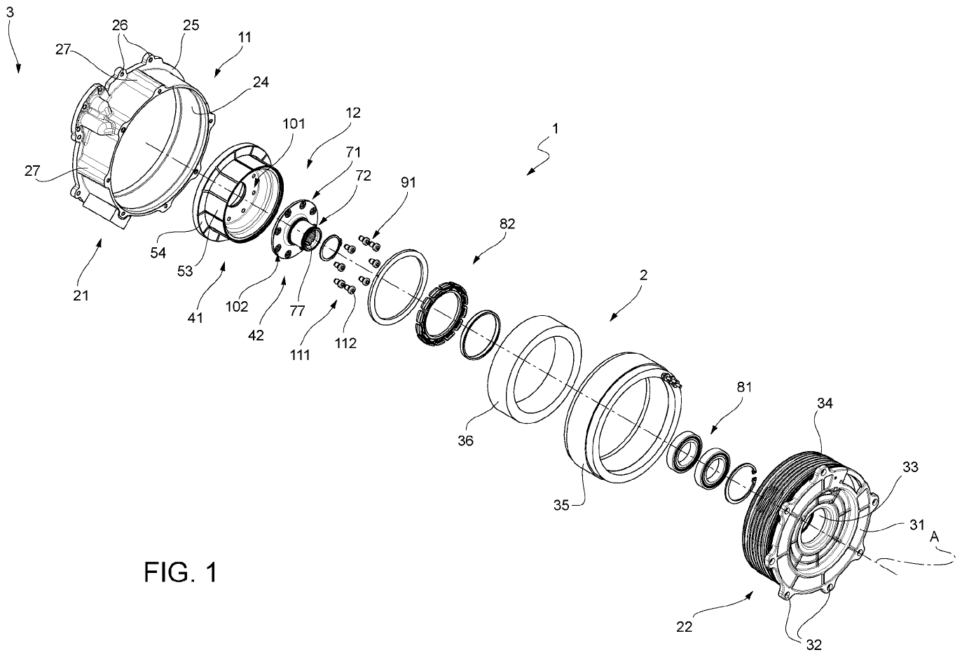

With reference to FIG. 1, there is indicated by 1 a transmission module according to the present invention.

The module 1 is configured to be connected between an internal combustion engine and a transmission of a hybrid drive vehicle, together forming a hybrid drive assembly which also comprises an electrical machine 2.

The module 1 is part of a hybrid unit 3 comprising, besides the module itself, the electrical machine 2. Conveniently, the electrical machine 2 is of reversible type, i.e. it can operate as an electrical motor to supply torque to the transmission or as a generator to generate electrical power.

The module 1 comprises a support structure 11 configured to be secured to the internal combustion engine and a transmission assembly 12 housed in the support structure 11 and configured to operatively connect a drive shaft of the internal combustion engine, the electrical machine 2 and the transmission to each other.

The support structure 11 comprises a fastening element 21 and a closing element 22 rigidly coupled to the fastening element 21 and defining therewith a housing 23 for the further components of the hybrid unit 3 described in detail hereinafter.

In particular, the fastening element 21 comprises a substantially cylindrical wall 24 extending along an axis A coincident, in use, with the axis of the drive shaft. The wall 24 is provided, at an axial end thereof, with a peripheral flange 25 which extends in radial direction from opposite side to the housing 23, and preferably orthogonally thereto, and which has a plurality of holes 26 for the securing to the internal combustion engine.

The wall 24 defines, from opposite side to the housing 23, a plurality of protrusions 27 which extend radially, starting from the wall 24, and axially along the entire extension of the wall 24 with respect to the axis A. Holes are obtained in the protrusions 27 for coupling the fastening element 21 to the closing element 22.

The closing element 22 comprises a substantially annular plate 31 of axis A provided with a plurality of radial projections 32, extending along its outer edge, which define respective through holes for the respective protrusions 27 of the wall 24. From the inner edge of the plate 31 a tubular appendage 33 extends axially, towards the flange 25.

Conveniently, the closing element 22 carries a sleeve 34 of axis A which extends axially towards the flange 25 and is externally in contact with the wall 24 of the fastening element 21, i.e. from opposite side to the housing 23.

The closing element 22 and the sleeve 34 define therebetween channels wherein a coolant liquid configured to cool the electrical machine 2 can flow. In particular, the electrical machine 2 comprises a stator 35 of axis A, externally in contact with the sleeve 34, and a rotor 36 coaxial to the stator 35 and radially internal with respect to it.

The transmission assembly 12, conveniently housed in the housing 23, comprises a first element 41, configured to be operatively connected to the engine and to the electrical machine 2, and a second element 42, configured to be connected to the transmission of the vehicle.

Conveniently, the first element 41 and the second element 42 are distinct components which are rigidly coupled to each other, as described in detail hereinafter.

The first element 41, which is conveniently axisymmetric with respect to the axis A, comprises a support portion 51 configured to support the rotor 36 of the electrical machine 2, and a connection portion 52 configured to be driven by the engine.

In particular, the support portion 51 of the first element 41 has a substantially annular shape around the axis A, and preferably has an L cross-section. In particular, the support portion 51 comprises a cylindrical wall 53 of axis A, which defines a radial support for the rotor 36, and a radial wall 54 of axis A, which defines an axial stop for the rotor 36 and extends from an axial end of the cylindrical wall 53 facing, in use, the engine. Conveniently, the support portion 51 is configured to rotate about the axis A together with the rotor 36.

The connection portion 52 of the first element 41 has a substantially annular shape and comprises a substantially cylindrical main body 55 and a radial appendage 56 extending towards the axis A from an axial end of the main body 55 facing the closing element 22.

Conveniently, the support portion 51 and the connection portion 52 are connected by a joint portion 61. In particular, the joint portion 61 comprises an outer radial wall 62, which extends from the cylindrical wall 53 of the support portion 51, an inner radial wall 63, which extends from the main body 55 of the connection portion 52, and an intermediate wall 64, which extends substantially axially and joins the outer radial wall 62 and the inner radial wall 63.

Conveniently, the support portion 51, the connection portion 52 and the joint portion 61 are made in one piece. The second element 42 of the transmission assembly 12 comprises a fastening portion 71 rigidly coupled to the first element 41 and a hub portion 72 coaxial to the first element 41.

In particular, the fastening portion 71 of the second element 42 comprises an annular plate 73, extending orthogonally with respect to the axis A, and a tubular appendage 74 of axis A which extends from an inner edge of the annular plate 73 and faces, in use, the engine. Conveniently, the annular plate 73 and the tubular appendage 74 are in axial and in radial contact, respectively, with the support portion 51 of the first element 41.

The hub portion 72 comprises a hub 75 of axis A extending in opposite direction with respect to the tubular appendage 74 and configured to be connected to the transmission of the vehicle, and an annular joint 76 between the annular plate 73 and the hub 75. Conveniently, the hub 75 internally has a groove 77 configured to allow the coupling between the hub 75 and the transmission of the vehicle.

Conveniently, the fastening portion 71 and the hub portion are made in one piece.

Preferably, the module 1 further comprises rolling support means 81 interposed between the support structure 11 and the transmission assembly 12.

In particular, the rolling support means 81 are bearings, preferably ball bearings, radially interposed between the sleeve 34 of the support structure 11 and the hub portion 72 of the transmission assembly 12.

Conveniently, the module 1 further comprises position sensors 82, of known type and not described in detail hereinafter, configured to measure the relative rotation of the transmission assembly 12, and thus of the rotor 36, with respect to the support structure 11.

Conveniently, the transmission assembly 12 comprises fastening means 91 configured to rigidly couple the first element 41 and the second element 42 to each other.

For this purpose, the first element 41 has a plurality of axial first holes 101 distributed around the axis A, and the second element 42 has a plurality of axial second holes 102. Each hole is defined by an axis, parallel to the axis A, and the second holes 102 are coaxial to the respective first holes 101. The first holes 101 and the second holes 102 are configured to house the fastening means 91.

Preferably, the first holes 101 are arranged on the connection portion 52 of the first element 41, and the second holes 102 are arranged on the fastening portion 71 of the second element 42.

Conveniently, the first holes 101 and the second holes 102 are arranged circumferentially around the axis A. In other words, the axes of the first holes 101, and thus the axes of the second holes 102, are equidistant from the axis A.

In particular, the first holes 101 and the second holes 102 can be angularly equispaced with respect to the axis A. In other words, if the number of the first holes 101 (and thus of the second holes 102) is n, it is possible to define n dihedral angles (i.e. n portions of space comprised between two half-planes) such that each dihedral angle has origin in the axis A, two half-planes passing through respective axes of the first holes 101 (and thus of the second holes 102) and does not contain other axes of the first holes 101 inside it. All the dihedral angles so defined have the same measure.

Conveniently, the first holes 101 and the second holes 102 are through holes.

According to a first embodiment of the invention (FIGS. 1-3), the fastening means 91 comprise first threaded elements 111. Preferably, the first threaded elements 111 are screws which extend parallel to the axis A and have respective heads 112 facing the closing element 22.

In particular, FIG. 1 illustrates eight threaded elements 111 arranged along a circumference and angularly separated by 45° from each other.

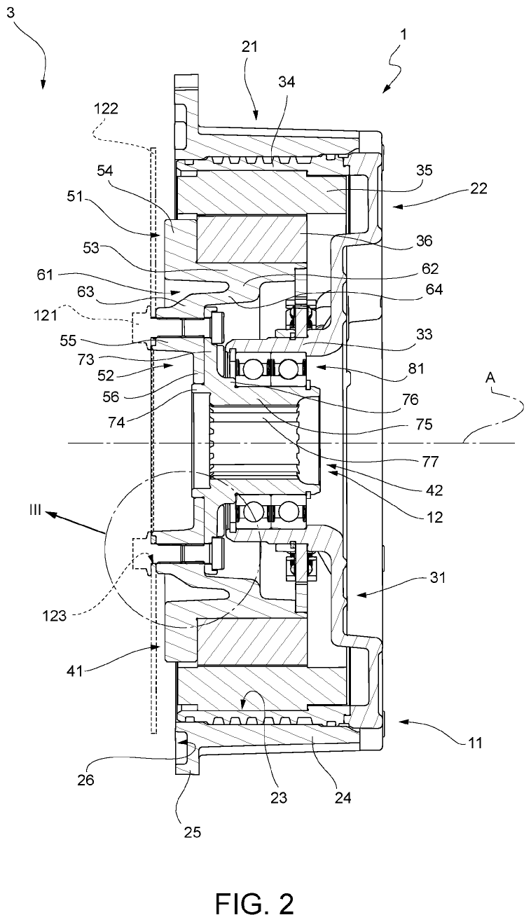

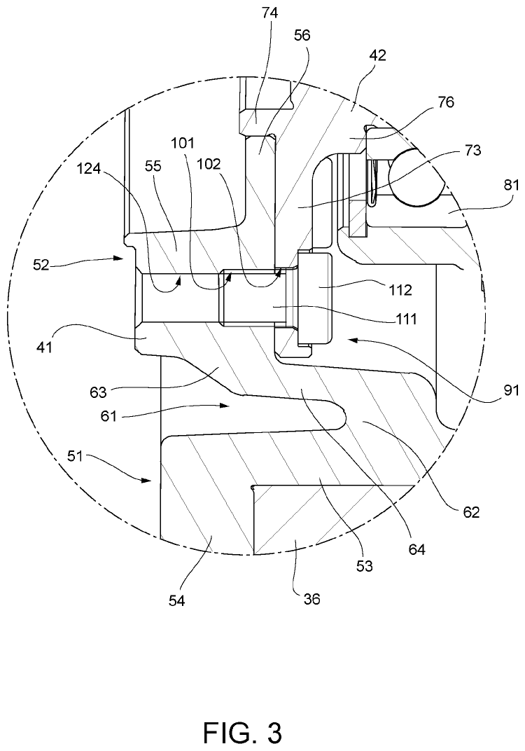

Conveniently (FIGS. 2 and 3), the first holes 101 are arranged on the main body 55 of the connection portion 52 of the first element 41, and the second holes 102 are arranged on the annular plate 73 of the fastening portion 71 of the second element 42.

In particular (FIG. 2), the first holes 101 are configured to house second threaded elements 121 configured to connect the first element 41 to a torque transmission element 122 operatively interposed between the engine and the first element 41 and provided with a plurality of axial holes 123, coaxial to the first holes 101. Conveniently, the torque transmission element 122 is a flexible disc or flex plate.

Conveniently, the first holes 101 and the second holes 102 have the same diameter. In other words, each pair of first hole 101 and respective second hole 102 defines a single threaded cylindrical through seat 124 which is configured to house a respective first threaded element 111 and a respective second threaded element 121. Preferably, the first holes 101 and the second holes 102 have the same thread, i.e. the cylindrical through seat 124 is uniformly threaded. It follows that also the first threaded elements 111 and the second threaded elements 121 have the same thread. Optionally, the first threaded elements 111 have the Same structure of the second threaded elements 121, i.e. can be used independently of each other.

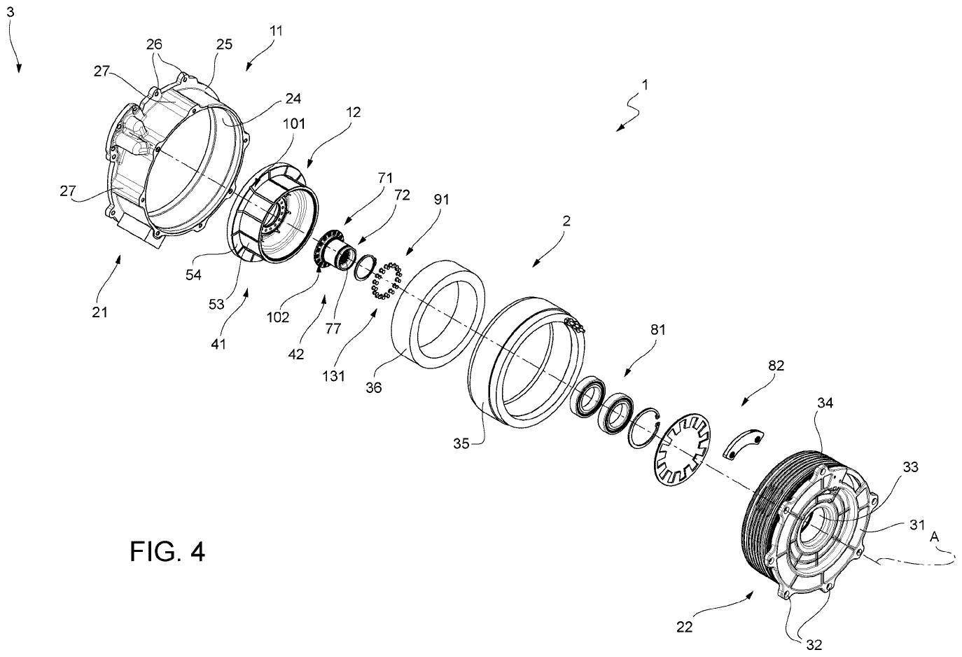

According to a second embodiment of the invention (FIGS. 4-6), the fastening means 91 comprise rivets 131 which extend parallel to the axis A.

In particular, FIG. 4 illustrates sixteen rivets 131 arranged along a circumference and angularly separated by 22,5° from each other.

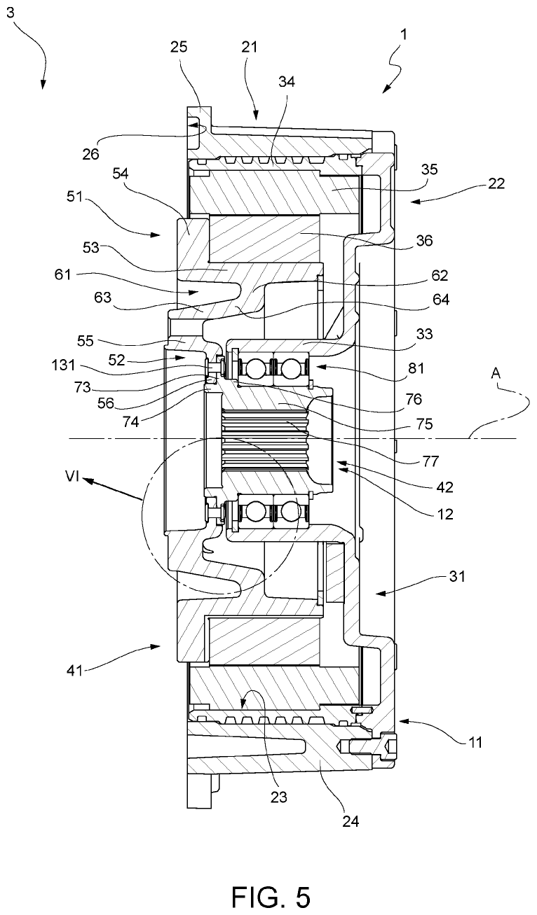

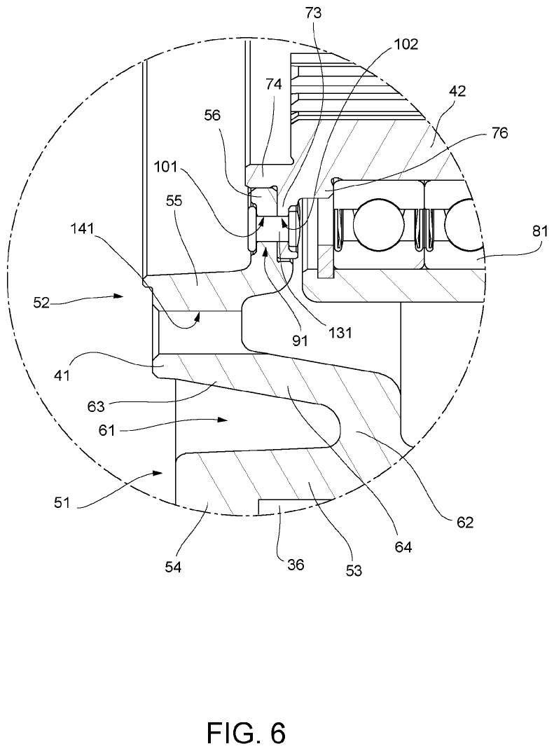

Conveniently (FIGS. 5 and 6), the first holes 101 are arranged on the radial appendage 56 of the connection portion 52 of the first element 41, and the second holes 102 are arranged on the annular plate 73 of the fastening portion 71 of the second element 42.

Conveniently (FIGS. 5 and 6), the first element 41 has a plurality of axial third holes 141 configured to house the second threaded elements 121 configured to connect the first element 41 to a torque transmission element (not illustrated), operatively interposed between the engine and the first element 41 and provided with a plurality of axial holes, coaxial to the third holes 141.

In particular (FIG. 5), the first holes 101 and the third holes 141 are arranged along circumferences centred on the axis A. In other words, the axes of the first holes 101 are equidistant from the axis A, and the axes of the third holes 141 are equidistant from the axis A. Conveniently, the distance between the axis A and the first holes 101 is less than the distance between the axis A and the third holes 141.

The operation of the module 1 according to the present invention is the following.

After mounting the module 1 on the vehicle, the transmission assembly 12 allows to connect the internal combustion engine to the transmission of the vehicle. Conveniently, the torque transmission element 122 is interposed between the engine and the first element 41 of the transmission assembly 12.

The electrical machine 2, connected to the first element 41, can be used both as a generator (for recharging the battery during thermal traction, or for generating an electrical power configured to power accessories of the vehicle, for example agricultural accessories, or as a regenerative brake) and as a motor for starting the internal combustion engine or for supplying an additional torque during thermal traction (boosting).

From the foregoing, the advantages of the module 1 according to the present invention are evident.

In particular, since the first element 41 and the second element 42 are distinct components, it is possible to manufacture them in different materials and/or via different production processes.

For example, the second element 42 must satisfy the hardness requirements of the groove 77 of the hub 75, and can thus be conveniently manufactured via forging. However, manufacturing the first element 41 and the second element 42 as a single forged component would require a complex mould and an expensive production process. Instead, according to the invention, the first element 41 is distinct from the second element 42 and can thus be made of another material, for example cast iron, and via another process, for example fusion. This simplification, in terms of development and costs, positively affects the entire module 1.

Furthermore, if the first element 41 and the second element 42 are coupled via the first threaded elements 111 housed in the first holes 101, it is possible to use the same holes 101 also to connect the first element 41 to the torque transmission element 122, for example a flexible disc or flex plate, operatively interposed between the engine and the first element 41.

Alternatively, the use of the rivets 131 to couple the first element 41 and the second element 42 allows to have a more compact coupling and less bulk, resulting particularly convenient when there are more stringent bulk constraints.

Finally, it is clear that modifications and variations can be made to the module 1 without going beyond the scope of protection defined by the claims.

For example, the first element 41 and the second element 42 could have a different structure from that described and be rigidly coupled to each other in other suitable ways.

Furthermore, the support structure 11 and the transmission assembly 12 could have a different structure from that described or comprise further elements, not described for the sake of brevity.

The distance between the axis A and the first holes 101 could be greater than the distance between the axis A and the third holes 141.

1. Transmission module for a hybrid drive assembly for a vehicle, the hybrid drive assembly comprising an internal combustion engine provided with a drive shaft, at least one electrical machine (2) and a transmission of the vehicle, the transmission module being configured to be interposed between the engine and the transmission and comprising:
a support structure (11) configured to be secured to the engine and defining a housing (23),
a transmission assembly (12) housed in the housing (23) defined by the support structure (11) and comprising a first element (41) and a second element (42),
wherein the first element (41) has an axis (A) coincident, in use, with the axis of the drive shaft and is configured to be operatively connected to the engine and the electrical machine (2),
wherein the second element (42) is configured to be connected to the transmission of the vehicle,
wherein the first element (41) and the second element (42) are distinct components which are rigidly coupled to each other.

2. The transmission module as claimed in claim 1, wherein the transmission assembly (12) comprises fastening means (91) configured to rigidly couple the first element (41) and the second element to each other.

3. The transmission module as claimed in claim 2, wherein the first element (41) comprises a support portion (51) configured to support a rotor (36) of the electrical machine (2) and a connection portion (52) configured to be driven by the engine, and the second element (42) comprises a fastening portion (71) rigidly coupled to the first element (41) and a hub portion (72) coaxial to the first element (41).

4. The transmission module as claimed in claim 3, wherein at least one of the connection portion (52) of the first element (41) and the fastening portion (71) of the second element (42) extends substantially orthogonally with respect to said axis (A).

5. The transmission module as claimed in claim 3, comprising rolling support means (81) interposed between the hub portion (72) and an end portion (33) of the support structure (11) extending substantially parallel to said axis (A).

6. The transmission module as claimed in claim 2, wherein the first element (41) has a plurality of axial first holes (101) distributed around said axis (A), the second element (42) has a plurality of axial second holes (102), coaxial to the first holes (101), the first holes (101) and the second holes (102) being configured to house the fastening means (91).

7. The transmission module as claimed in claim 6, wherein the first holes (101) and the second holes (102) are arranged circumferentially about said axis (A).

8. The transmission module as claimed in claim 6, wherein the first holes (101) and the second holes (102) are angularly equispaced with respect to said axis (A).

9. The transmission module as claimed in claim 6, wherein the first holes (101) and the second holes (102) are through holes.

10. The transmission module as claimed in claim 2, wherein the fastening means (91) comprise first threaded elements (111).

11. The transmission module as claimed in claim 10, wherein the first element (41) has a plurality of axial first holes (101) distributed around said axis (A), the second element (42) has a plurality of axial second holes (102), coaxial to the first holes (101), the first holes (101) and the second holes (102) being configured to house the fastening means (91), wherein the first holes (101) are configured to house second threaded elements (121) configured to connect the first element (41) to a torque transmission element (122) operatively interposed between the engine and the first element (41) and provided with a plurality of axial holes (123), coaxial to the first holes (101).

12. The transmission module as claimed in claim 11, wherein the first holes (101) and the second holes (102) have the same diameter.

13. The transmission module as claimed in claim 12, wherein the first holes (101) and the second holes (102) have the same thread.

14. The transmission module as claimed in claim 2, wherein the fastening means (91) comprise rivets (131).

15. The transmission module as claimed in claim 14, wherein the first element (41) has a plurality of axial third holes (141) configured to house second threaded elements (121) configured to connect the first element (41) to a torque transmission element (122) operatively interposed between the engine and the first element (41) and provided with a plurality of axial holes (123), coaxial to the third holes (141).

16. The transmission module as claimed in claim 15, wherein the first element (41) has a plurality of axial first holes (101) distributed around said axis (A), the second element (42) has a plurality of axial second holes (102), coaxial to the first holes (101), the first holes (101) and the second holes (102) being configured to house the fastening means (91), wherein the first holes (101) and the second holes (102) are arranged circumferentially about said axis (A), wherein the distance between said axis (A) and the first holes (101) is less than the distance between said axis (A) and the third holes (141).
